(19) United States
(12) Patent Application Publication
(10) Pub. No.: US 2024/0110029 A1
(43) Pub. Date: Apr. 4, 2024

(54) PANEL, COMPOSITION FOR IMPREGNATING OR COATING A PANEL, AND A METHOD FOR PRODUCING A PANEL

(71) Applicant: Champion Link International Corporation, The Valley (AI)

(72) Inventors: Thomas Luc Martine BAERT, Sint-Martens-Latem (BE); Tom VAN POYER, Jiaxing (CN); Sven BOON, Jiaxing (CN)

(73) Assignee: Champion Link International Corporation, The Valley (AI)

(21) Appl. No.: 18/060,097

(22) Filed: Nov. 30, 2022

(30) Foreign Application Priority Data
Sep. 30, 2022 (NL) 2033198

(51) Int. Cl. C08J 7/04; C08J 7/043

(52) U.S. Cl. CPC C08J 7/042; C08J 7/043; C08J 2301/02; C08J 2375/06; C08J 2379/02

(57) ABSTRACT

The invention relates to a panel, in particular a floor panel, comprising at least one core layer; and at least one top layer comprising at least one polymer, wherein at least one polymer comprises trifunctional groups. The invention also relates to a composition for impregnating or coating a top layer of a panel with a polymer.

### CROSS REFERENCE TO RELATED APPLICATIONS

This application claims priority under 35 U.S.C. § 119 to Netherlands Patent Application No. 2033198, filed Sep. 30, 2022, which is incorporated herein by reference in its entirety.

### FIELD OF THE INVENTION

The present invention relates to a panel, in particular a floor panel, a composition for impregnating or coating such a panel, and a method for producing such a panel.

### BACKGROUND

Direct pressure laminate (DPL) is a prevalent type of flooring on the market. It is produced by applying a pressure of about 2 to 20 Mpa under elevated temperatures of about 140-200° C. onto multiple layers, generally comprising from top to bottom at least one décor paper layer, a wood-based core, and at least one balancing paper layer, each generally comprising a thermoset resin, thereby laminating them together. The decorative top layer can further comprise at least one transparent overlay paper. Generally, the top decorative layer comprises at least one layer of lignocellulose and is generally impregnated with a thermoset resin, generally a melamine urea formaldehyde (MUF) resin, which cures and hardens during the DPL production process, leaving the decorative top layer rigid and brittle, but with a very high strength, providing resistance to scratches and stains as its main advantages. A variation on this DPL product uses a thermoplastic core layer instead of a wood-based core, combined on its top surface with at least one thermoset resin impregnated decorative top layer and on its bottom surface with at least one thermoset resin impregnated balance paper. To adhere a thermoset resin impregnated layer onto this thermoplastic core layer, an additional polymeric adhesive layer is applied between the resin impregnated layer and core layers. A suitable type of adhesive comprises a thermosetting resin and a polymeric adhesive or epoxy. The high temperatures applied during the DPL production process can damage the core, but are at the same time required to cure the MUF resin and/or polymeric adhesive layers.

MUF resins are poly-condensation products of the reaction of formaldehyde with urea and melamine. Melamine has three amine groups which form nodes during the crosslinking of the three components. These nodes form a very dense and rigid structure, providing strength to the crosslinked MUF resin. Under industrial conditions, the degree of crosslinking of MUF resin is however difficult to control. When formed, urea formaldehyde (UF) is as a result generally not fully crosslinked with melamine, leaving functional hydroxyl (OH) groups present in the reacted resin. These functional hydroxyl groups attract water molecules through van der Waals forces, thus making the MUF resin hydrophilic.

When UF or MUF is used to impregnate a part or layer of a panel, such as a decorative top layer, said part or layer of the panel is therefore prone to take up moisture. Some decorative top layers, such as cellulose based top layers, are by nature also dimensionally unstable when exposed to temperature and/or moisture fluctuations. The effect of water on (ligno)cellulose is significant because it comprises hydroxyl, amino and carboxyl hydrophilic groups, resulting in expansion after moisture absorption and shrinkage after drying. (Ligno)cellulose is known to swell to multiple times its own size when it contacts water, and to contract to a fraction of its swollen size when dried. The combination of moisture sensitive (ligno)cellulose with the dense, rigid, and hydrophilic MUF structure after curing, has the effect of decreasing stability further. For example, a sheet of paper of 90 grams impregnated with 140 wt. % of MUF resin, crosslinked at 180-200° C. during 30-40 seconds, will exhibit a shrinking rate of anywhere between −0.8% to −2.3% according to ISO 23999. The water absorption rate of such a sheet of paper ranges between 1.5-3% when submerged in water for 2 hours at 23° C. The strength, crosslinking density, and sensitivity to moisture of MUF after curing combined with the swelling due to the relatively high moisture absorption rate and contraction of (ligno)cellulose fibres results in a dimensionally unstable construction, requiring the use of a balance paper at the back of the panel to balance out the forces exerted on it.

In addition, MUF resins are detrimental to the environment and to human health due to the generally incomplete reaction of formaldehyde to form MUF. Formaldehyde is a toxic and harmful volatile organic compound (VOC) which pollutes the indoor environment where the MUF impregnated panels are produced and stored.

There is thus a need for a panel, preferably a panel having a decorative top layer comprising at least one polymeric and/or thermoset resin and a core, that has an improved dimensional stability when exposed to moisture while retaining the surface performance of state-of-the-art direct pressure laminates. There is also a need for a panel which does not, or to a lesser extent, pollute the indoor environment where the panel is produced and/or stored. Finally, there is a need for a panel having an enhanced stability while retaining the surface performance of state-of-the-art direct pressure laminates.

In a first aspect, the present invention provides for this need a (decorative) panel, in particular a floor panel, comprising: at least one core layer; and at least one top layer, the at least one top layer comprising at least one polymeric resin, wherein the at least one polymeric resin comprises trifunctional allophanate groups and/or trifunctional isocyanurate groups.

The panel according to the present invention has several benefits over conventional panels. The application of a top layer comprising at least one polymeric resin comprising trifunctional allophanate groups and/or trifunctional isocyanurate groups results in the at least one top layer having a shrinking rate equal to or below 0.2%, measured according to ISO 23999. The top layer of the panel according to the present invention does not exhibit hydrophilic characteristics, and is therefore resistant to the influence of water. The polymeric resin and the resulting top layer can therefore be said to be non-hydrophilic and/or hydrophobic, and as such, the stability of the top layer and the panel itself is enhanced. In addition, there are no harmful VOCs present in the panel or released from the panel, when it is produced or stored. The shrinking rate equal to or below 0.2% and pliability of the at least one top layer allows the construction of a panel that does not require a balancing layer to be provided on the bottom surface of the panel as there are no stresses exerted on the top surface of the core by the at least one top layer.

Allophanate as defined within the context of the present invention is an anionic conjugate base of allophanic acid (H₂NC(O)NHCO₂H). An allophanate group can be attached to the rest of a molecule via up to three bonds to both nitrogen atoms and via an oxygen atom. A trifunctional isocyanurate group is a group that is attached to the rest of a molecule via up to three bonds to all three nitrogen atoms. The corresponding acid, cyanuric acid, or 1,3,5-triazine-2,4,6-triol ((CNOH)₃) is typically a cyclic trimer of cyanic acid (HOCN). Trifunctional means that in the resulting formed polymer, the respective molecule forms three chemical bonds.

Preferably, the at least one polymeric resin is at least partially entangled. Hence, the at least one top layer may comprise at least one at least partially entangled polymeric resin, in particular comprising trifunctional allophanate groups and/or trifunctional isocyanurate groups. The at least partially entangled polymeric resin may comprise at least one entangled polymer. This provides additional strength to the resin, as entangled polymers are more fixed in position when compared to non-entangled polymers. Entanglement can occur within a polymer chain or between polymer chains. Reticular or spherical structures are formed, preventing normal movement of the entangled polymer molecule and thus affecting its properties. The molecular weight of polymers that are able to entangle is generally at least 10 000 to 20 000 g/mol.

It is conceivable that the panel according to the invention comprises multiple top layers. It is conceivable that at least one top layer, possibly multiple top layers, or each top layer comprises a polymeric resin according to the present invention. It is conceivable that at least one overlay layer, possibly multiple overlay layers, comprises a polymeric resin or a composition according to the present invention.

In a preferred embodiment, at least one top layer comprises cellulose, lignocellulose, paper, wood, or any combination thereof. These materials are able to form a mesh like structure and the polymeric resin comprising trifunctional allophanate groups and/or trifunctional isocyanurate groups can be present within this structure. As such, the polymeric resin can be distributed evenly throughout these materials, improving its stability when exposed to changes in humidity as the top layer will not absorb water in humid environments, as it is thoroughly impregnated with the non-hydrophilic and/or hydrophobic polymeric resin.

Preferably, the at least partially entangled polymeric resin is present in at least 25 wt. %, preferably at least 30 wt. %, more preferably at least 35 wt. %, in particular based on total weight of the top layer. It is also possible that at least one entangled polymeric resin is present in at most 70 wt. %, preferably at most 45 wt. %. in particular based on total weight of the top layer. A preferred embodiment comprises at least one entangled polymeric resin present between 40 wt. % and 60 wt. %, in particular based on total weight of the top layer. It has been found that these weight concentrations of entangled polymer result in a top layer that does not attract any moisture.

The at least one entangled polymer may be present in 40-80 wt. %, preferably 50-70 wt. %, more preferably 55-65 wt. %, most preferably about 60 wt. %, based on total weight of the at least partially entangled polymeric resin.

The panel according to the invention preferably comprises at least two pairs of opposing side edges wherein at least one pair of opposite side edges, and preferably each pair of opposite side edges, is provided with complementary coupling parts. In a preferred embodiment, at least one pair of opposite side edges of the core layer is provided with complementary coupling parts. Yet in a further preferred embodiment, at least one and preferably each pair of opposite side edges is provided with complementary coupling parts. Hence, it is conceivable that at least one conductive structure is provided upon at least part of a coupling part. The complementary coupling parts, if applied, are typically configured for interconnecting adjacent panels. For example, the core layer comprises at least one pair of complementary coupling parts on at least two of its opposite side edges. Said coupling parts may for example be interlocking coupling parts configured for mutual coupling of adjacent panels in multiple directions. Preferably, said interlocking coupling parts provide locking in both horizontal and vertical directions. Any suitable interlocking coupling parts as known in the art could be applied. For example, said interlocking coupling parts may be in the form of complementary tongue and groove, male and female receiving parts, a projecting strip and a recess configured to receive said strip or any other suitable form. It is conceivable that the complementary coupling parts require a downward scissoring motion when engaging, or are locked together by means of a horizontal movement. It is further conceivable that the interconnecting coupling mechanism comprises a tongue and a groove wherein the tongue is provided on one side edge of one pair of opposite side edges, and the groove is provided on the other side edge, or an adjacent side relative to that of the tongue, of the same pair of opposite side edges. Such a design of coupling mechanism is well-known in the art and has proven highly suitable for panels for floor coverings such as a floating floor. In a further embodiment it is possible that the interconnecting coupling mechanism has an interlocking feature which prevents interconnected panels from any free movement (play). Such an interlocking feature may be a projection and a respective recess provided on the respective opposite side edges by which neighboring panels interlock with each other. It is conceivable for provisions of reinforcement in the interlocking coupling parts to improve strength and prevent breakage thereof during installation of the panels. For example, the complementary or interlocking coupling parts may be reinforced with materials such as but not limited to fiberglass mesh, reinforcing sheets, ceramics, glass, arrays of non-metallic rods, or polymer compounds integrally formed in the core layer. It is also conceivable that a strengthening coat layer of micro or nanotechnology is added to the surface of the interlocking coupling parts. In case such coating is applied, the at least one conductive structure is applied upon said coating.

The top layer can for example be a decorative top layer. The top layer preferably comprises at least one décor layer and/or at least one finishing layer. At least one finishing laying can for example be a UV-cured coating, an electron-beam modified resin, an excimer-cured coating, and/or an acrylic or polyurethane coating.

It is conceivable that at least one décor layer is attached to at least part of the core layer. It is also conceivable that the décor layer is a print layer. It is also possible that at least one decorative pattern is formed by relief provided in the upper core surface of the core layer or panel. A primer may be applied prior to applying the decorative pint. The top layer is possibly a thermoplastic layer. However, it is also possible that at least one top layer comprises a plurality of impregnated layers containing lignocellulose, preferably impregnated with a composition according to the present invention. At least one top layer can also be a veneer, for example a wood veneer. The top layer may for example comprise at least one cellulose-based ply and preferably multiple cellulose-based plies. Said cellulose-based ply may for example be paper, in particular kraft paper. The veneer layer, if applied, is preferably selected from the group comprising of wood veneer, cork veneer, bamboo veneer, and the like. Other materials such as a rubber veneer, a decorative plastic or vinyl, linoleum, and laminated decorative thermoplastic material in the form of foil or film would be conceivable. In case at least one thermoplastic top layer is applied, the thermoplastic material can be PP, PET, PVC and the like.

In an embodiment, the top layer may comprise, silicon oxide (SiO₂), aluminum oxide (Al₂O₃), graphene, silicone rubber, titanium dioxide (TiO₂), zinc oxide (ZnO), zinc sulfide (ZnS), corundum, silicon carbide, quartz, and/or silicon dioxide, preferably present in the top layer as particles. This results in a top layer having an enhanced wear-resistance, abrasion-resistance, and scratch-resistance. In addition, or alternatively, particles having a Mohs hardness of at least 8, most preferably at least 9, such as silicon carbide or diamond particles, can be present in the top layer. The top layer of the panel may comprise antimicrobial, antiviral, antibacterial, and/or antifungal agents preferably disposed on an upper surface of the top layer, integrated, or embedded in the top layer. Microorganisms can be present in the top layer of a panel. In particular if the panel comprises cellulose. These microorganisms can potentially damage the top layer. Antimicrobial, antiviral, antibacterial and/or antifungal agents can inhibit growth or kill the microorganisms, thereby preventing damage to the top layer. In another embodiment, the top layer comprises one or more slip resistant additives, preferably on an outer surface of the top layer.

In case the top layer comprises an overlay, coating or finish layer comprising at least one polymeric resin according to the invention, the overlay, coating or finish layer may have a thickness in the range of 0.2 to 0.8 mm, preferably in the range of 0.4 to 0.6 mm.

The surface roughness of at least part of the overlay, coating or finish layer, in particular, an upper surface of the overlay, coating or finish layer, is preferably at least 1 μm Ra, preferably at least 2 μm Ra, more preferably at least 3 μm Ra. At least part of the coating layer may comprise a plurality of micro-undulations while maintaining a surface roughness (Ra) of at least 3 μm, wherein at least a part of the micro-undulations has a peak to valley height (Rz) of 5 μm or less and/or wherein at least a part of the micro-undulations has a peak to valley height (Rz) of at least 5 μm. At least part of the coating layer may also comprise a plurality of micro-undulations while maintaining a surface roughness (Ra) of at least 3 μm, wherein at least a part of the micro-undulations has a peak to valley height (Ry) of 5 μm or less and/or wherein at least a part of the micro-undulations has a peak to valley height (Ry) of at least 3 μm.

The upper surface of the overlay, coating or finish layer may comprise varying surface heights forming peaks and valleys. Different dimensional characteristics can be measured using the said surface heights, peaks, and valleys. These dimensional characteristics must be specified to positively affect the slip resistance of the surface. For example, R3z or the mean of the third maximum peak-to-valley heights in the evaluation length can preferably be set to at least 5 μm. Moreover, the maximum height of the third highest peak to the third lowest valley in each cut-off length, denoted by R3y, can also be preferably set to at least 5 μm. Such embodiment would enable sufficient slip resistance for the surface of the coating layer, and thus for the panel as such. The obtained roughness and/or peak to valley height can for example be achieved by having multiple coating layers each with micro-undulations and/or micro creases with a compounding effect. As such, the microstructures function as a means for increasing the slip resistance of the surface of the coating layer.

The panel, and in particular the core layer may comprise a composite material. The core layer may for example be a composite core layer. The core layer may for example comprise a filler and at least one binder. The binder can be selected from, but is not limited to, thermoplastic or thermoset resins including but not limited to vinyl, polyvinyl chloride (PVC), polyethylene (PE), polyurethane (PU), acrylonitrile butadiene styrene (ABS), melamine, and/or polypropylene (PP). Preferably, the ratio of weight percentages of filler relative to binder is at least 1:1, more preferably at least 2:1, most preferably at least 3:1. The filler material used in the core layer can comprise organic or inorganic materials which includes but is not limited to cellulose materials, fibrous materials, kraft paper, saw dusts, wood dusts, wood fibers, long wood fibers, short wood fibers, plants-based fibers such as mushroom fibers, cotton fibers, bamboo fibers, abaca fibers, pineapple fibers, sand, lime, volcanic ash, magnesium compounds, magnesium oxide, magnesium carbonate, limestone, polymeric fibers, glass fibers, carbon-based fibers, polymeric pellets, or hollow microspheres or particles having size ranging from 1 to 1000 micrometers made of but is not limited to ceramics, glass, polymers, composites, or metals. In a preferred embodiment the core layer can comprise at least one additive material, advantageously including surface active substances (surface active substances, SAS), such as methyl cellulose, “Badimol” plasticizing materials and other cationic active SAS, to improve the rheology of the mixture. The core layer may also include bentonite, which is a finely ground natural product suitable for increasing the rheological and waterproof properties of the panel itself. In yet a further preferred embodiment, the core layer is substantially free of conductive particles. The composite material of the core layer can be substantially free of conductive particles and/or conductive material.

It is conceivable that at least one core layer, if applied, comprises a composite material, in particular a mineral composite material. The core layer may for example comprise a magnesium oxide or MgO-based composite. The core layer may for example comprise MgCl2 and/or MgSO4. The composite core layer may for example comprise at least 20% by weight of magnesium oxide. A non-limiting example of a possible composite core layer, is a core layer comprising 30 to 40% by weight magnesium oxide, 10 to 20% by weight magnesium chloride or magnesium sulfate, 10 to 15% by weight water, 5 to 10% by weight magnesium hydroxide, 5 to 10% by weight calcium carbonate, 5 to 50% by weight lignocellulose (e.g. wood fibers or cork) and/or 10-15% by weight additives. It is found that a composite core layer, in particular a mineral composite core layer, has a good stability to heat which is also beneficial for the panel as such. The density of at least one core layer is preferably between 1200 and 2000 kg/m3, more preferably between 1400 and 1600 kg/m3. However, it is also conceivable that the density of at least one core layer is about 2000 kg/m3. The latter is for example possible when the core layer comprises a thermoplastic mineral composite. The mineral material can be selected from the group of magnesium oxide, magnesium carbonate, magnesium oxysulfate, magnesium oxychloride cement (MOC), magnesium chloride (MgCl2), magnesium sulfate (MgSO4), Sorel cement, fiber cement, MOS cement, limestone, calcium carbonate, calcite mineral, stone, chalk, clay, calcium silicate and/or talc. In some embodiments, the mineral material is preferably present as particulate mineral filler of at least 200 mesh, preferably more than 300 mesh. The thermoplastic mineral composite core layer may for example comprise 60 to 70% by weight of calcium carbonate, 20 to 25% by weight of polyvinyl chloride and possibly 5 to 10% by weight of additives. At least one core layer may comprise a density gradient, for example wherein the density near the upper surface is higher than the density near the bottom surface, or wherein the density near the upper surface and the bottom surface is higher than the density of a central region situated between said upper surface and bottom surface. A further non-limiting example of a possible core layer is an HDF based core layer comprising cellulose and a thermosetting resin. It is also conceivable that the core is a wood-based core comprising cellulose and/or a geopolymer based on magnesium oxide. The core can also be a foamed core. The panel and/or the core is preferably waterproof.

In a preferred embodiment, the core layer has a maximum thickness of 8 mm, more preferably 6 mm, or most preferably 4 mm. The core layer is also referred to as substrate. The substrate or core layer preferably comprises at least partially a polymeric resin further comprising trifunctional allophanate groups, trifunctional isocyanurate groups, or mixtures (or combinations) thereof. Due to the enhanced stability of the core layer at least partially comprising the polymeric resin or composition according to the present invention, the thickness of the core layer can be further decreased to the thicknesses mentioned above. In addition, the thickness of the core layer may even range between 3-4 mm, while still being sufficiently stable.

Additionally or alternatively, the width of the panel may be at least 200 mm, more preferably 250 mm, and most preferably at least 300 mm. A width of the panel of 600 mm is even envisageable, as the stability of the panel is sufficiently enhanced by the decorative top layer comprising the at least one polymeric resin or composition according to the invention. In line with the above, the length of the panel may be at least 1.8 m, such as at least 2.2 m as a result of this enhanced stability.

It is also conceivable that the core layer may comprise other core materials such as, but not limited to: wood, engineered wood, wood plastic composite (WPC), medium density fiberboard (MDF), high density fiberboard (HDF), green fiberboard, organic materials, mycelium, or mixtures (or combinations) thereof.

Preferably, the core layer comprises a lignocellulose based core material. In particular, this core layer is impregnated with the composition according to the present invention. It is conceivable that the core layer is at least partially impregnated with the composition according to the present invention. It is further conceivable that the core layer is sealed on at least one core surface, preferably the upper and/or bottom surfaces, with the composition according to the present invention. It is also conceivable that at least one of the side edges or surfaces of the panel or core, more preferably at least part of the surface of the complementary or interlocking coupling parts as described hereinabove are at least partially impregnated or coated with the composition. The at least partial sealing of the lignocellulose based core layer on at least one core surface has a beneficial effect on the water resistance of the panel, enabling the panel and/or the core to achieve a swell rate of less than 2%, preferably less than 1%, when tested according to the NALFA Laminate Flooring Specifications and Test Methods LF 01-2011:3.2 Thickness Swell.

The core layer may further comprise a resilient material or thermoplastic and a filler, chosen from the groups of polyvinyl chloride (PVC), polypropylene (PP), polyurethane (PU), polyethylene (PE), polyethylene terephthalate (PET), acrylonitrile butadiene styrene (ABS), or combinations thereof.

The core layer may also comprise at least one mineral-based material such as magnesium-based compounds, magnesium oxide (MgO), magnesium chloride (MgCl or MOC cement), magnesium oxysulfate (otherwise known as MOS cement), calcium carbonate (CaCO₃), chalk, clay, calcium silicate, talc, gypsum, or mixtures (or combinations) thereof.

Preferably, the core layer further includes at least one additional filler selected from the group consisting of steel, glass, polypropylene (PP), wood, acrylic, alumina, curaua, carbon, cellulose, coconut, Kevlar, Nylon, perlon, polyethylene (PE), polyvinyl acetate (PVA), rock wool, viburnum and fique. This addition of the said fillers further increases the strength of the panel or may add other properties to the panel such as water resistance and/or fire resistance.

The core layer may also comprise a combination or composite of any of the materials previously mentioned. It is conceivable that the composite material comprises at least 20% by weight of filler and/or 15% to 50% by weight of a binder. This range is found to provide sufficient stability and strength of the core layer while also allowing for necessary flexibility thereof and improving temperature resistance as well. Preferably, the core layer has a density of at least 800 kg/m³, preferably at least 1400 kg/m³. The density of the core layer could for example be in the range of 1600 to 2100 kg/m³.

The core layer may for example have a thickness of at least 4 mm. It is for example possible that the thickness of the core layer is between 3 and 9 mm, preferably between 4 mm and 5.5 mm or between 5.5 mm and 7 mm. It is conceivable that at least one core layer comprises at least one reinforcing layer. The reinforcing layer can for example be a reinforcing mesh. Possibly, the core comprises at least two reinforcing layers, wherein a first reinforcing layer is located near the upper surface and wherein a further reinforcing layer is located near the bottom surface. Preferably, at least one reinforcing layer comprises a mesh or web, preferably comprising fiberglass, jute and/or cotton.

The panel may comprise at least one further layer, such as but not limited to a backing layer. In case a backing layer is applied, the backing layer can be adhered on the bottom core surface of the core layer via an adhesive. The backing layer is preferably made of a polymer material, for example but not limited to polyurethane. The backing layer may also be a sound absorbing layer. Such sound absorbing backing layer may further contribute to the good acoustic properties of the panel. Such backing layer may also be referred to as an acoustic layer. The backing layer may be composed of a foamed layer, preferably a low-density foamed layer, of ethylene-vinyl acetate (EVA), irradiation-crosslinked polyethylene (IXPE), expanded polypropylene (XPP) and/or expanded polystyrene (XPS). However, it is also conceivable that the backing layer comprises nonwoven fibers such as natural fibers like hemp or cork, and/or recycled/recyclable material such as PET. The backing layer, if applied, preferably has a density between 65 kg/m3 and 300 kg/m3, most preferably between 80 kg/m3 and 150 kg/m3. It is also conceivable that the panel comprises at least one adhesive layer on the bottom surface of the core layer, or the backing layer if applied. Said glue layer may be a conductive adhesive layer or a conductive glue layer.

The invention also relates to a panel, in particular a floor panel, comprising at least one core layer and at least one top layer, preferably at least one polymeric resin impregnated top layer, wherein said polymeric resin comprises trifunctional allophanate groups and/or trifunctional isocyanurate groups. This embodiment can be combined with any of the described embodiments according to the invention. The invention also relates to a panel, in particular a floor panel, comprising at least one core layer and at least one top layer, wherein at least one top layer comprises at least one support layer and at least one coating layer, wherein said coating layer comprises at least one polymeric resin comprising trifunctional allophanate groups and/or trifunctional isocyanurate groups. The support layer can for example be a thermoplastic top layer. This embodiment can be combined with any of the described embodiments according to the invention.

In a second aspect, the present invention relates to a composition for impregnating or coating a top layer of a panel, in particular a panel according to the present invention, said composition comprising at least 1 wt. % of at least one diisocyanate, at least 1 wt. % of at least one polyamine, and/or at least 30 wt. % of at least one acrylate polymer, in particular based on total weight of the composition. The at least one polyamine can be a diamine. Diisocyanate, polyamine and acrylate polymer can form an entangled polymer network wherein the entangled polymer network comprises trifunctional allophanate groups and trifunctional cyanurate groups. When a top layer of a panel is impregnated with this composition and is crosslinked, surprisingly, the resulting top layer is pliable. Due to the absence of free hydroxyl groups in the top layer of the panel, the top layer is non-hygroscopic and/or hydrophobic, and therefore hardly swells in humid environments nor shrinks in dry environments. The composition could also form a coating layer upon the top layer.

It is also conceivable that the complementary or interlocking coupling parts as described hereinabove are at least partially impregnated or coated with the composition. It is possible to coat at least partially a top and/or bottom surface of a core of a panel as described hereinabove with the composition as well.

Acrylate polymers are a group of polymers that are composed of acrylate monomers. Acrylate polymers are also known as polyacrylates.

The at least one acrylate polymer may have a molecular weight of at least 10000 g/mol, preferably at least 15000 g/mol, more preferably at least 20000 g/mol, and most preferably at least 30000 g/mol.

The at least one acrylate polymer may be entangled. This further increases the strength of the acrylate polymer and of a top layer coated with the composition containing the acrylate polymer.

Preferably, the weight percentage of the at least one diisocyanate in the composition according to the invention is higher than the weight percentage of the at least one polyamine. This is an interesting embodiment as this ensures that all polyamines can first react with diisocyanates, whereafter any excess diisocyanate reacts with the acrylate polymer. This way, the crosslinking process can be controlled, and it is ensured that the resulting polymer network is not too heavily crosslinked. As a result, a panel, core layer, and/or top layer coated or impregnated with the composition has an enhanced stability and its strength is reduced, limiting stress on the panel, core layer and/or top layer. Surprisingly, the top layer is pliable as well.

The composition is preferably liquid at least 20° C. and 1 atm. The composition can be a bulk solution, an emulsion, or a solution and/or can be referred to as a solution. Typically, the composition is not an aqueous solution. Diisocyanates should not be dissolved in water, as they would quickly hydrolyse, before being able to react with polyamines. As all components are either liquids or dissolved, they can be homogenously mixed, ensuring a homogenous composition for impregnating a top layer of a panel.

In an embodiment, a ratio of the weight percentage of the at least one diisocyanate to the weight percentage of the at least one polyamine is at least 1.01:1, preferably at least 1.05:1. In a further preferred embodiment, a ratio of the weight percentage of the at least one diisocyanate to the weight percentage of the at least one polyamine is between 1.08:1 and 1.12:1. It was unexpectedly found that a top layer, impregnated, or coated, with a composition having such a ratio of diisocyanates to polyamines, has high pliability which proves advantageous for industrial applications. It is suitable for direct lamination, direct pressure lamination, multi-roller processes, and roller-based multilayer-forming apparatuses or machines. The top layer can be directly laminated to a core layer, carrier layer, carrier plate, substrate, carrier core, stone plastic composite (SPC) core, polymer core, plastic core, wood-based core, cent-based core, stone core, and cementitious material.

Preferably, the at least one diisocyanate is selected from 1,6-diisocyanatohexane, 4,4′-diisocyanatodicyclohexylmethane, methylene-bis-phenyl isocyanate, toluene diisocyanate, hexamethylene diisocyanate, naphthalene diisocyanate, methylene bis-cyclohexylisocyanate, isophorone diisocyanate, hydrogenated methylene-bis-phenyl isocyanate, isophorone diisocyanate, or any combination thereof.

The at least one polyamine may be a spatially encumbered polyamine. Preferably, the at least one polyamine may be a spatially encumbered triamine or diamine. The spatial encumbrance prevents excessive crosslinkage of a polymer formed by the compounds in the composition. As such, any panel impregnated or coated with the composition remains pliable, even after curing of the composition.

Preferably, the at least one polyamine is selected from 6-phenyl-1,3,5-triazine-2,4-diamine, 2,4-diamino-6-phenyl-1,3,5-triazine, 1,3,5-triazine-2,4,6-triamine, modified 1,3,5-triazine-2,4,6-triamine, or any combination thereof.

The acrylate polymer may be selected from a polyurethane modified acrylate polymer, a polyurethane modified methacrylate, a polyurethane modified cyanoacrylate, polyacrylate, or any combination thereof.

The weight percentage of the at least one diisocyanate can be at least 2 wt. %, preferably at least 3 wt. %, in particular based on total weight of the composition. Possibly, the weight percentage of the at least one diisocyanate can be at most 4.5 wt. %, preferably at most 5 wt. %, in particular based on total weight of the composition. It is also conceivable that the weight percentage of the at least one diisocyanate is between 1 wt. % and 5 wt. %, in particular based on total weight of the composition.

The weight percentage of the at least one polyamine can be at least 2 wt. %, preferably at least 3 wt. %, in particular based on total weight of the composition. It is also conceivable that the weight percentage of the at least one polyamine is at most 4.5 wt. %, preferably at most 4 wt. %, in particular based on total weight of the composition. The weight percentage of the at least one polyamine can also be between 1 wt. % and 5 wt. %, in particular based on total weight of the composition.

The weight percentage of the at least one acrylate polymer can be at least 25 wt. %, at least 30 wt. % or at least 35 wt. %, in particular based on total weight of the composition. It is also conceivable that the weight percentage of the at least one acrylate polymer is at least 40 wt. %, or more preferably between 40 wt. % and 60 wt. %, in particular based on total weight of the composition. The weight percentage of the at least one acrylate polymer can for example also be at most 70 wt. %, at most 60 wt. % or most 50 wt. %, in particular based on total weight of the composition.

Preferably, the composition comprises further at least one adhesive. It is for example also conceivable that the composition comprises at least one adhesive component. The presence of at least one adhesive enables the top layer to adhere to the core in an efficient and effective manner. The presence of at least one adhesive may also have a positive effect on the viscosity of the composition, making the composition easy to handle. It also obviates the need for any further, separately applied adhesive layers.

The acrylate polymer and the adhesive can form an interpenetrating polymer network (IPN). An IPN is a polymer that comprise a plurality of polymers, each forming a network, wherein the networks are interlaced. The networks are typically not covalently bonded to each other, but separation of the networks requires chemical bonds to be broken. The at least one polymeric resin may thus comprise an at least partially interpenetrating polymer network. A decorative top layer comprising at least one polymeric resin comprising an interpenetrating polymer network comprising at least one adhesive is therefore able to adhere to a multitude of substrates without requiring a further adhesive layer to be provided between the top layer and the core or substrate layer.

At least one adhesive, if applied, may comprise polyvinyl acrylate, polyurethane, reactive polyurethane, methylmethacrylate, ethylene-vinyl acetate, an epoxy, or any combination thereof. These adhesives are suitable to provide an adhesive function for the top layer being sticked to the core.

Preferably, at least one adhesive, if applied, is present in at least 20 wt. %, preferably at least 25 wt. %, in particular based on total weight of the composition. It is also conceivable that the composition comprises in the range of 20 wt. % to 35 wt. %, in particular based on total weight of the composition, of at least one adhesive.

In a third aspect, the present invention relates to a method for impregnating or coating a top layer of a panel, in particular a floor panel, said panel comprising at least one top layer and at least one core layer, the method comprising the following steps:
a) providing a composition according to the present invention;
b) applying at least part of the composition on at least one top layer and/or impregnating at least one top layer with the composition; and
c) heating at least part of the top layer to a temperature of at least 80° C. such that at least part of the diisocyanate, the polyamine, and/or the acrylate polymer will crosslink.

The resulting top layer of the floor panel is pliable, rollable, and roller-compatible. As such it can even be wrapped around a mandrel with a smallest diameter of 10 mm when tested according to ASTM F137 Standard Test Method for Flexibility of Resilient Flooring Materials with Cylindrical Mandrel Apparatus and/or ISO 24344 Resilient floor coverings—Determination of flexibility and deflection. The stability of the top layer is greatly improved as well. When exposed to moisture, the top layer will not, or to a much lesser extent, absorb water. In addition, the temperature stability of the top layer is improved and it resists elongation and shrinkage when exposed to temperature and/or humidity fluctuations.

Preferably, the method comprises a step of providing the top layer onto a core layer after step b) and prior to step c). The method may also include the provision of at least one core layer and at least one top layer. The method may further include the provision of at least one bottom layer comprising at least partially the composition according to the present invention and/or applying the composition on at least one further surface of the core or panel, preferably on at least the bottom surface and/or at least one side edge of the core or panel. The method may include the application of an interlocking mechanism on at least one side edge of the panel and/or the application of at least partially the composition according to the present invention to at least part of the surface of the interlocking mechanism.

Preferably, the top layer comprises cellulose, lignocellulose, paper, wood, or any combination thereof. Any of the possible top layers and/or core layers are described for the corresponding panel according to the invention can be included in the method according to the invention. It is conceivable that the top layer comprises a thermoplastic such as polyvinyl chloride, polypropylene, polyethylene terephthalate and the like.

In an embodiment, in step c) the top layer is heated at a temperature of at least 100° C., preferably at least 120° C. Said heating step is preferably applied for at least 10 seconds, more preferably at least 30 seconds. These times and/or temperatures are sufficient to crosslink the resin, such that a pliable material is obtained.

In a fourth aspect, the present invention relates to a panel obtainable via a method as described hereinabove.

In a fifth aspect, the present invention relates to a panel, in particular a floor panel, comprising: at least one core layer; and at least one top layer; wherein the top layer has a shrinking rate of at most 0.5%, preferably at most 0.3%, more preferably at most 0.2%, most preferably at most 0.1%, measured according to ISO 23999.

Preferably, the at least one top layer of the panel as described in the first aspect or the fifth aspect, has a water absorption rate when the top layer is submerged in water of 23° C. during two hours of less than 2.5 wt. %, preferably less than 1 wt. %, even more preferably less than 0.5 wt. %, most preferably less than 0.2 wt. %, based on total weight of the top layer.

The at least one top layer may comprise lignocellulose.

Preferably, the panel comprises at least one polymeric resin, wherein the at least one polymeric resin comprises allophanate groups and/or isocyanurate groups.

Preferably, the at least one polymeric resin comprises trifunctional allophanate groups and/or trifunctional isocyanurate groups.

Preferably, the at least one top layer of the panel can be plied around a mandrel with a smallest diameter of 10 mm when tested according to ASTM F137 and/or ISO 24344.

In a preferred embodiment, the present invention relates to a composition for impregnating or coating a top layer of a panel comprising 1.0-1.5 wt. % of at least one diisocyanate, 1.0-1.5 wt. % of at least one polyamine, 50-70 wt. % of a polyurethane modified acrylate polymer, and 15-30 wt. % polyvinyl acetate, based on total weight of the composition.

### EXAMPLES

A non-limiting example of a top layer of a panel according to the present invention was created using the compounds listed in Table 1.

TABLE 1
Panel composition

| | | | Weight | |
|---|---|---|---|---|
| | | | percentage [%] | |
| Compound | | CAS | Relative | Relative |
| category | Compound | number | to total | to resin |
| Carrier | Lignocellulose Fibre | | 45.8 | |
| Additive | Titanium dioxide | 13463-67-7 | 21.5 | |
| Resin | Polyurethane modified | | 19 | 58.1 |
| | acrylate | | | |
| | Polyvinyl acetate | | 7.5 | 22.9 |
| | Aluminum silicate | 12141-46-7 | 3.3 | 10.1 |
| | Aluminium phosphate | 7784-30-7 | 1.6 | 4.9 |
| | Benzoguanamine | 91-76-9 | 0.4 | 1.2 |
| | Magnesium silicate | 1343-88-0 | 0.3 | 0.9 |
| | 1,6-Diisocyanatohexane | 822-06-0 | 0.2 | 0.6 |
| | 4,4′-Diisocyanato | 13622-90-7 | 0.2 | 0.6 |
| | dicyclohexylmethane | | | |
| | Caprolactam | 105-60-2 | 0.1 | 0.3 |
| | Other | | 0.1 | 0.3 |

The composition for coating or impregnating a top layer of the panel (Resin in Table 1) contains 58.1 wt. % of polyurethane modified acrylate, as the acrylate polymer. The resin comprises 1.2 wt. % benzoguanamine, or 6-fenyl-1,3,5-triazine-2,4-diamine, as a polyamine. The diisocyanates in the resin are 0.6 wt. % 1,6-Diisocyanatohexane (HDI, or 1,6-hexane diisocyanate) and 0.6 wt. % 4,4′-diisocyanato dicyclohexylmethane (hydrogenated MDI). The ratio of weight percentages of diisocyanates to polyamines in the resin equals 1:1, as there is 1.2 wt. % of diisocyanates and 1.2 wt. % of polyamine present in the resin.

Both diisocyanates (HDI and hydrogenated MDI) enable crosslinking with the polyurethane modified acrylate. Owing to the molecular weight of the polyurethane modified acrylate and its relatively high (58.1 wt. %) concentration in the resin, the polyurethane modified acrylate is entangled.

The resin of Table 1 comprises 22.9 wt. % polyvinyl acetate (PVA/PVAc) that functions as an adhesive. This resin can used as an impregnating material for a decorative top layer, such as a paper layer, resulting in a resin-impregnated paper layer. The resin-impregnated paper layer is heated before being fed to a roller lamination machine. During this process, microparticles of the resin start to coalesce and form larger particles creating an interpenetrating polymer network (IPN).

The paper layer impregnated with the emulsion of polyvinyl acetate (PVA/PVAc) and polyurethane modified acrylate has a lower water absorption rate and will take up less moisture as compared to a melamine impregnated decorative paper layer. This is achieved due to the absence of unreacted and/or free hydrophilic OH groups in the resin.

The paper layer has shrinking rate of less than 0.2% measured according to ISO 23999.

The invention will be further elucidated by means of the following non-limitative clauses.

1 Panel, in particular a floor panel, comprising:
at least one core layer; and
at least one top layer comprising at least one polymeric resin, wherein at least one polymeric resin comprises trifunctional allophanate groups and/or trifunctional isocyanurate groups.
   2. Panel according to clause 1, wherein the at least one polymeric resin is at least partially entangled.
   3. Panel according to clause 1 or clause 2, wherein at least one top layer further comprises cellulose, lignocellulose, paper, wood, or any combination thereof.
   4. Panel according to any of clauses 1-3, wherein at least one polymer resin, and preferably at least one entangled polymer, is present in at least 30 wt. %, preferably at least 35 wt. %, more preferably between 40 wt. % and 60 wt. %, based on total weight of the at least one top layer.
   5. Panel according to any of clauses 1-4, comprising at least two pairs of opposing side edges wherein at least one pair of opposite side edges, and preferably each pair of opposite side edges, is provided with complementary coupling parts.
   6. Composition for impregnating or coating a top layer of a panel, in particular a panel according to any of clauses 1-5, said composition comprising at least 1 wt. % of at least one diisocyanate, at least 1 wt. % of at least one polyamine and at least 30 wt. % of at least one acrylate polymer, in particular based on total weight of the composition.
   7. Composition according to clause 6, wherein the at least one acrylate polymer is at least partially entangled.
   8. Composition according to clause 6 or clause 7, wherein the weight percentage of the at least one diisocyanate is higher than the weight percentage of the at least one polyamine.
   9. Composition according to any of clauses 6-8, wherein the composition is liquid at 20° C. and 1 atm.
   10. Composition according to any of clauses 6-9, wherein a ratio of the weight percentage of the at least one diisocyanate to the weight percentage of the at least one polyamine is at least 1.01:1, preferably at least 1.05:1, most preferably between 1.08:1 and 1.12:1.
   11. Composition according to any of clauses 6-10, wherein the at least one diisocyanate is selected from 1,6-diisocyanatohexane, 4,4′-diisocyanatodicyclohexylmethane, methylene-bis-phenyl isocyanate, toluene diisocyanate, hexamethylene diisocyanate, naphthalene diisocyanate, methylene bis-cyclohexylisocyanate, isophorone diisocyanate, or any combination thereof.
   12. Composition according to any of clauses 6-11, wherein the at least one polyamine is a spatially encumbered polyamine.
   13. Composition according to any of clauses 6-12, wherein the at least one polyamine is selected from 6-phenyl-1,3,5-triazine-2,4-diamine, 2,4-diamino-6-phenyl-1,3,5-triazine, 1,3,5-triazine-2,4,6-triamine, modified 1,3,5-triazine-2,4,6-triamine, or any combination thereof.
   14. Composition according to any of clauses 6-13, wherein the at least one acrylate polymer is selected from a polyurethane modified acrylate polymer, a polyurethane modified methacrylate, a polyurethane modified cyanoacrylate, polyacrylate, or any combination thereof.
   15. Composition according to any of clauses 6-14, wherein the weight percentage of the at least one diisocyanate is at least 2 wt. %, preferably at least 3 wt. %, more preferably between 1 wt. % and 5 wt. %, in particular based on total weight of the composition.
   16. Composition according to any of clauses 6-15, wherein the weight percentage of the at least one polyamine is at least 2 wt. %, preferably at least 3 wt. %, more preferably between 1 wt. % and 5 wt. %, in particular based on total weight of the composition.
   17. Composition according to any of clauses 6-16, wherein the weight percentage of the at least one acrylate polymer is at least 35 wt. %, preferably at least 40 wt. %, more preferably between 40 wt. % and 60 wt. %, in particular based on total weight of the composition.
   18. Composition according to any of clauses 6-17, comprising at least one adhesive.
   19. Composition according to clause 18, wherein the adhesive comprises polyvinyl acrylate, polyurethane, reactive polyurethane, methylmethacrylate, ethylene-vinyl acetate, an epoxy, or any combination thereof.
   20. Composition according to clause 18 or clause 19, wherein at least one adhesive is present in at least 20 wt. %, preferably at least 25 wt. %, more preferably between 20 wt. % and 35 wt. %, based on total weight of the composition.
   21. Method for impregnating or coating a top layer of a panel, in particular a floor panel, said panel comprising at least one top layer and at least one core layer, said method comprising the following steps:
a) providing a composition according to any of clauses 6-20;
b) applying at least part of the composition on at least one top layer and/or impregnating at least one top layer with the composition; and
c) heating at least part of the top layer to a temperature of at least 80° C. such that at least part of the diisocyanate, the polyamine, and/or the acrylate polymer will crosslink.
   22. Method according to clause 21, comprising a step of providing the top layer onto a core layer after step b) and prior to step c).
   23. Method according to clause 21 or clause 22, wherein at least one top layer comprises cellulose, lignocellulose, paper, wood, or any combination thereof.
   24. Method according to any of clauses 21-23, wherein in step c) the top layer is heated at a temperature of at least 100° C., preferably at least 120° C., preferably for at least 10 seconds, more preferably at least 30 seconds.

It will be apparent that the invention is not limited to the examples described, but that numerous variants are possible within the scope of the attached claims that will be obvious to a person skilled in the art. It is not necessary to elaborate on examples of all conceivable combinations of the above-described inventive concepts, as a person skilled in the art will understand numerous inventive concepts can be (re)combined in order to arrive at a specific application.

The verb “comprise” and conjugations thereof used in this patent publication are understood to mean not only “comprise”, but are also understood to mean the phrases “contain”, “substantially consist of”, “formed by” and conjugations thereof. As used herein, the term “polymeric resin” is understood to mean not only “polymeric resin”, but also “polymer”.

1. A panel for forming a floor covering, comprising:
at least one core layer; and
at least one top layer comprising at least one polymeric resin, wherein at least one polymeric resin comprises trifunctional allophanate groups and/or trifunctional isocyanurate groups.

2. The panel according to claim 1, wherein the at least one polymeric resin is at least partially entangled.

3. The panel according to claim 1, wherein the at least one top layer further comprises cellulose, lignocellulose, paper, wood, or any combination thereof.

4. The panel according to claim 1, wherein the at least one polymer resin is present in at least 30 wt. %.

5. The panel according to claim 1, comprising at least two pairs of opposing side edges wherein at least one pair of opposite side edges, and preferably each pair of opposite side edges, is provided with complementary coupling parts.

6. A composition for impregnating or coating a top layer of a panel, said composition comprising at least 1 wt. % of at least one diisocyanate, at least 1 wt. % of at least one polyamine and at least 30 wt. % of at least one acrylate polymer.

7. The composition according to claim 6, wherein the at least one acrylate polymer is at least partially entangled.

8. The composition according to claim 6, wherein the weight percentage of the at least one diisocyanate is higher than the weight percentage of the at least one polyamine.

9. The composition according to claim 6, wherein the composition is liquid at 20° C. and 1 atm.

10. The composition according to claim 6, wherein a ratio of the weight percentage of the at least one diisocyanate to the weight percentage of the at least one polyamine is at least 1.01:1 or wherein the weight percentage of the at least one polyamine is between 1.08:1 and 1.12:1.

11. The composition according to claim 6, wherein the at least one diisocyanate is selected from 1,6-diisocyanatohexane, 4,4′-diisocyanatodicyclohexylmethane, methylene-bis-phenyl isocyanate, toluene diisocyanate, hexamethylene diisocyanate, naphthalene diisocyanate, methylene bis-cyclohexylisocyanate, isophorone diisocyanate, or any combination thereof.

12. The composition according to claim 6, wherein the at least one polyamine is a spatially encumbered polyamine.

13. The composition according to claim 6, wherein the at least one polyamine is selected from 6-phenyl-1,3,5-triazine-2,4-diamine, 2,4-diamino-6-phenyl-1,3,5-triazine, 1,3,5-triazine-2,4,6-triamine, modified 1,3,5-triazine-2,4,6-triamine, or any combination thereof.

14. The composition according to claim 6, wherein the at least one acrylate polymer is selected from a polyurethane modified acrylate polymer, a polyurethane modified methacrylate, a polyurethane modified cyanoacrylate, polyacrylate, or any combination thereof.

15. The composition according to claim 6, wherein the weight percentage of the at least one diisocyanate is at least 2 wt. % and/or wherein the weight percentage of the at least one polyamine is at least 2 wt. %.

16. The composition according to claim 6, wherein the weight percentage of the at least one acrylate polymer is at least 35 wt. %, preferably at least 40 wt. %, more preferably between 40 wt. % and 60 wt. %, in particular based on total weight of the composition.

17. The composition according to claim 6, comprising at least one adhesive, wherein the adhesive comprises polyvinyl acrylate, polyurethane, reactive polyurethane, methylmethacrylate, ethylene-vinyl acetate, an epoxy, or any combination thereof, and wherein the at least one adhesive is present in at least 20 wt. %.

18. A method for impregnating or coating a top layer of a panel, said panel comprising at least one top layer and at least one core layer, said method comprising the following steps:
a) providing a composition according to claim 6;
b) applying at least part of the composition on at least one top layer of the panel and/or impregnating at least one top layer of the panel with said composition; and
c) heating at least part of the top layer of the panel to a temperature of at least 80° C. such that at least part of the diisocyanate, the polyamine, and/or the acrylate polymer will crosslink.

19. The method according to claim 18, comprising a step of providing the top layer onto a core layer after step b) and prior to step c).

20. The method according to claim 18, wherein at least one top layer comprises cellulose, lignocellulose, paper, wood, or any combination thereof and/or wherein in step c) the top layer is heated at a temperature of at least 100° C. for at least 10 seconds.
